(19) United States
(12) Patent Application Publication
(10) Pub. No.: US 2011/0151066 A1
(43) Pub. Date: Jun. 23, 2011

(54) FOLDABLE ROOT VEGETABLE FOOD SHEET

(76) Inventor: Scott Messervey, Florenceville (CA)

(21) Appl. No.: 12/975,548

(22) Filed: Dec. 22, 2010

Related U.S. Application Data
(60) Provisional application No. 61/289,688, filed on Dec. 23, 2009.

(51) Int. Cl. A23P 1/08; A23L 1/05; A23L 1/212; A23L 1/0522; A23L 1/03

(52) U.S. Cl. 426/102; 426/89; 426/103; 426/512; 426/661; 426/578

(57) ABSTRACT

The disclosure relates to a foldable vegetable shred food sheet useful, for example, as a bread substitute and/or a food wrap. The food sheet comprises vegetable pieces and a gelling agent such as, potato shred and starch. The food sheet of the disclosure has the unique ability to be folded and used like a tortilla wrap. The disclosure also provides for a wrapped food product comprising a potato food wrap fully or partially wrapped around a filling and relates to a method for preparing a wrapped food product. The disclosure also relates to methods of forming a food wrap or pasta noodle.

### CROSS REFERENCE TO RELATED APPLICATIONS

This nonprovisional application claims priority from U.S. provisional application U.S. 61/289,688 filed on Dec. 23, 2009, which is incorporated herein by reference in its entirety.

### FIELD

This application discloses a foldable root vegetable food sheet.

### BACKGROUND

Food sheets have many uses. For example, wraps are typically disc-shaped and folded around fillings, such as sliced vegetables, scrambled egg or meat, to provide a convenient hand-held meal. A good wrap must be foldable so that it can contain the filling to prevent it from dripping. Tortilla wraps are a popular type of wrap, typically made from unleavened flatbread. They are frequently used to make dishes such tacos, burritos and enchiladas, with or without meat. Food sheets may also be used flat, as a base for toppings, such for a pizza crust or a noodle such as a lasagne noodle. In these uses, the food sheet may be rigid or foldable. Food sheets may also be torn or cut into smaller pieces and dipped. These small pieces may be foldable when dipped, similar to pieces of pita bread, or they may be baked or fried until they are rigid chips, such as nacho chips.

Food sheets can be made out of many different ingredients, such as wheat, corn, rice or potato. Wheat is one of the most commonly used grains for breads, tortillas and flat noodles. Wheat flour contains wheat starch and proteins which hold other ingredients together and add structure to sheets. Wheat starch swells and gelatinizes when it is hydrated and heated. Proteins such as gluten are typically fibrous, which adds texture and structure to food (Y. H. Hui, Ed. Handbook of Food Science (2005, Marcel Dekker Inc)).

A concern with wheat is that many people have wheat intolerance, making wheat difficult to digest, and potentially causing effects such as nausea, diarrhea and vomiting. In some cases wheat is allergenic, causing an immune response to wheat proteins that can lead to symptoms such as upset stomach, vomiting, asthma and potentially anaphylaxis. Celiac disease is one example of an autoimmune disorder triggered by components of wheat flour. There is a need to make foldable food sheets (wraps) with non-allergenic alternatives to wheat flour.

There is also a growing interest among some consumers in foods made from vegetables that have undergone less processing. Grains used in foldable sheets, such as corn, rice, wheat and potatoes are typically processed into powdery, ground flours. Other times, the vegetable is processed to mash or flakes, and may be dehydrated or extruded. One example of a less processed food is a whole grain flour. However, there remains an interest in using vegetable products made from more intact vegetable components. A problem with using larger vegetable components is that they can typically only be formed into relatively thick foods that are not suitable for making wraps, chips or as a continuous base for supporting other toppings on top. An omelet is one example of a carrier for large vegetable components, but it is too soft to be hand-held and it is also allergenic to those with egg allergies. Other carriers tend to be relatively rigid and thick, such as potato cakes and latkes, and unsuitable for use as a wrap or hand-held food product. There remains a need for a foldable food sheet that can replace food sheets made from flour.

### SUMMARY OF THE DISCLOSURE

The inventor has developed a food sheet made from vegetable pieces that has the strength and flexibility to be used as a sheet in place of conventional wraps and other breads, noodles and chips.

The food sheet typically includes a flexible layer that includes vegetable pieces and a gelling composition (typically the gelling composition includes a plurality of gelling agents, such as a starch composition including a plurality of types of starches). The gelling composition forms a matrix in conjunction with the vegetable pieces adhering the pieces in the form of a sheet. The matrix is typically solid in order to hold the vegetable pieces together, for example, when the food sheet is bent or folded (the solid matrix is typically resilient to touch). Typically a sheet has shred uniformly disposed therein. In one embodiment of the invention, the gelling composition is a starch composition. The sheet is typically solid and resilient.

The vegetable pieces of the food sheet are optionally shreds, dices or slices (i.e. shredded vegetables or sliced vegetables), with and/or without peel attached. In an embodiment, the vegetable shreds, dices or slices are blanched. Suitable dimensions of shreds and slices will be readily apparent. For example for potato and other root vegetables, suitable shreds are optionally: 1 to 10 mm thick, 1 to 10 mm wide and 12 to 50 mm long. In another embodiment, the shreds are 1 to 3 mm thick, 1 to 6 mm wide and 2 to 50 mm long.

In another embodiment, the vegetable pieces of the food sheet are from a root vegetable. In another embodiment, the vegetable pieces are potato. In a further embodiment, the vegetable pieces are sweet potato, yam, yucca, cassava, onion, shallot, carrot or taro.

In a further embodiment of the invention, the flexible layer comprises interlaced vegetable shreds. The food sheet is typically formed in a continuous uniform layer, which helps it maintain shape and resist moisture damage. It is also typically resiliently foldable such that it can be bent without the continuous layer of shredded vegetable pieces breaking or tearing. The food sheet can optionally be folded at least: 45, 90, 120, 150, 180, 200, 250, 300 or 360 degrees. In another embodiment of the invention, the food sheet can be folded into a tube, such as a cylinder shape, or folded into a pair of opposed semicircular surfaces.

The food sheet is typically 1 to 10 mm thick, 10 to 300 mm wide and 20 to 200 mm long. In a further embodiment, the layer of the food sheet is 1 to 5 mm in thickness. The layer is optionally 3 to 4 mm in thickness. In yet another embodiment, the layer is circular and the ratio of the diameter to height of the sheet is optionally: 1-2:100, 1-2:250 or 1-2:500.

In a further embodiment of the invention, the food sheet optionally contains up to 5%, and optionally 5-10%, 5-25% or 5-50% of a secondary vegetable. In a further embodiment, the secondary ingredient is a root vegetable, optionally sweet potato, garlic, ginger or onion. Secondary vegetables are useful to add color, flavour or texture to the sheet. They are also useful carriers for exogenous flavors.

In a further embodiment of the invention, the food sheet contains up to 1%, optionally 1-2% or 1-5% by weight of a herb, seasoning or flavouring, such as oregano, basil, fennel, cumin, mustard, whole grains, cilantro or parsley.

In another embodiment of the invention, the food sheet contains up to 10% fruit pieces or up to 10% fruit puree.

The starch composition of the invention optionally includes at least one of the following starches: sago starch, waxy maize starch, maize starch, rice starch, waxy rice starch, barley flour/starch, pea flour/starch, potato starch, wheat starch, tapioca starch, lotus starch, sweet potato starch/flour or starch/flour from millets, pulses or lentils. The flour/starches of the starch composition can be native (unmodified) or modified by physical, chemical or enzymatic methods. Optionally, the starches are instant starches or cook-up starches.

In one embodiment, the starch composition includes a mixture of at least two starches. In a further embodiment, the starch composition includes sago starch and waxy maize starch. Optionally, the starch composition can include 2 or more waxy maize starches. In yet another embodiment, the starches of the starch composition are i) sago starch, ii) instant modified waxy maize starch and iii) cook-up modified waxy maize starch. In a further embodiment, the sago starch is modified sago starch.

In one embodiment of the invention, the food sheet comprises, or is made (formed) from, the following ingredient amounts: 90-96% vegetable pieces by weight, 0.05-3% sago starch by dry weight, 0.05-3% instant modified waxy maize starch by dry weight and 0.05-3.5% cook-up modified waxy maize starch by dry weight. In another embodiment, the food sheet comprises, or is made from, 85-96% vegetable pieces by weight plus second ingredients, typically so that dry starch is 10% by total weight or less of the ingredients. Optionally the starch is 0.05-2.5% sago starch by dry weight, 0.05-2.0% instant modified waxy maize starch by dry weight and 0.05-2.5% cook-up modified waxy maize starch by dry weight. In another embodiment, the food sheet comprises, or is made from, 94-96% vegetable pieces by weight, 1.7-2.5% sago starch by dry weight, 1.0-1.5% instant waxy maize starch by dry weight and 1.7-2.5% cook-up waxy maize starch by dry weight. The foregoing percentages are applicable to the raw sheet (ie. raw ingredients) or the food sheet after cooking (i.e. cooked ingredients, with adjustments to subtract water added to the gelling composition from the weight percentages and adjusting for loss of water from the vegetable pieces during cooking, such as 5-20% or more water loss). The chosen percentages will vary depending on the properties desired in the food sheet and a skilled person will appreciate that the percentages can be adjusted.

In a further embodiment of the invention, the food sheet is free of gluten and/or any egg products.

The invention also relates to a wrapped food product comprising a food wrap fully or partially wrapped around a filling. In a further embodiment of the invention, the food sheet of the wrapped food product is fully folded around the filling creating a food-tight seal that prevents the filling from leaking through the body of the food sheet. The wrapped food product contains the filling when upright, e.g. when held upright by a user.

In yet another embodiment, the invention includes a noodle, such as a pasta-style noodle, formed from the food sheet. In a further embodiment, the noodle is a lasagna style noodle or a cannelloni style noodle.

In a further embodiment, the invention relates to a method of forming a food wrap or a pasta noodle, comprising contacting vegetable pieces with a food additive composition and gelling the food additive composition to form a matrix around the vegetable pieces.

The invention also relates to the use of the food sheet and filling for the preparation of a food product. The invention further relates to a method of preparing a wrapped food product where the food sheet is fully or partially folded around a filling. The filling of the food product or method optionally comprises egg, burrito filling, tortilla filling, samosa filling, egg roll filling, spring roll filling, sandwich meat, ground meat, vegetables, cheese, salad or fruit.

The invention also relates to food compositions per se (i.e. gelling compositions or food additive compositions), not merely in combination with vegetable pieces. In one embodiment, the food additive composition contains sago starch and waxy maize starch. The starches can be modified or unmodified. In a further embodiment, the food additive composition contains i) sago starch, ii) instant modified waxy maize starch and iii) cook-up modified waxy maize starch. In yet another embodiment of the food additive composition, the sago starch, instant waxy maize starch and cook-up waxy maize starch are in the ratio of 1:1:1 to 1.7:1:1.7 by dry weight.

The invention further relates to the use of the food additive composition for the preparation of a food sheet.

The invention also relates to a method of forming a food sheet, using the following steps: (1) contacting root vegetable food pieces with the food additive composition described above, (2) forming the root vegetable food pieces into a raw sheet, and (3) gelling the food additive composition to form a solid matrix around the root vegetable food pieces, thereby converting the raw sheet to the food sheet.

In a further embodiment, the step of contacting root vegetable shred with the food additive composition forms a dough. The forming step can use pressure to form the dough into a raw sheet. Optionally, the forming step is accomplished by applying 5 to 500 PSI of pressure to the dough with a press. In one embodiment, the pressure forming step is performed at ambient temperature, optionally 16-25° C., 17-19° C. or 18° C. In another embodiment, the pressure forming step is performed below ambient temperature, optionally 4-18° C. or 4-8° C. Alternatively, the dough may be contacted with a prescribed heat treatment and a pressure of 5 to 500 PSI.

In a further embodiment, the dough is sheeted by any other sheeting method known in the art and cut into desired size and shape.

In another embodiment, the gelling step includes heating the raw sheet to set the starches to bind with the food pieces to form the food sheet. Optionally, the gelling step includes heating the raw sheet to 55-95° C., optionally 65-90° C., 70-85° C. or 80° C. In a further embodiment, the gelling step includes heating the raw sheet until at least a portion of the vegetable pieces turn darker, for example, golden or shades of brown, caused by browning due to the heat.

The disclosure also shows use of the food additive (gelling) compositions described herein and vegetable pieces for preparation of a food sheet. The method of forming a food sheet optionally comprises:
contacting root vegetable food pieces with a food additive composition;
forming the root vegetable food pieces into a raw sheet;
gelling the food additive composition to form a solid matrix around the root vegetable food pieces, thereby converting the raw sheet to the food sheet.

The step of contacting root vegetable shred with the food additive composition typically forms a dough. The forming step typically involves pressure forming the dough into the raw sheet, optionally by applying 5-500 PSI of pressure to the dough, such as with a press. The pressure forming step is optionally performed at ambient temperature, for example 16-25° C., 17-19° C. or 18° C. or optionally at below ambient temperature, for example 4-18° C. or 4-8° C.

The gelling step typically comprises heating the raw sheet to set the starches to bind with the food pieces to form the food sheet. Heating the raw sheet is optionally at 200-300° C., typically 230-280° C. Typically, the gelling step comprises heating the raw sheet to a core temperature of 55-95° C., optionally 80° C. and/or until at least a portion of the vegetable pieces become darkened.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from the detailed description.

### BRIEF DESCRIPTION OF THE DRAWINGS

Embodiments of the invention will be shown in relation to the drawings in which:

FIG. 1 shows (a) a top view of two potato food sheets and (b) a close-up top view of one of the potato food sheets.

FIG. 2 shows a potato food sheet folded at approximately a) 45, b) 90, c) 150, d) 180, e) 360 degrees.

FIG. 3 shows a potato food sheet formed into a tube.

### DETAILED DESCRIPTION

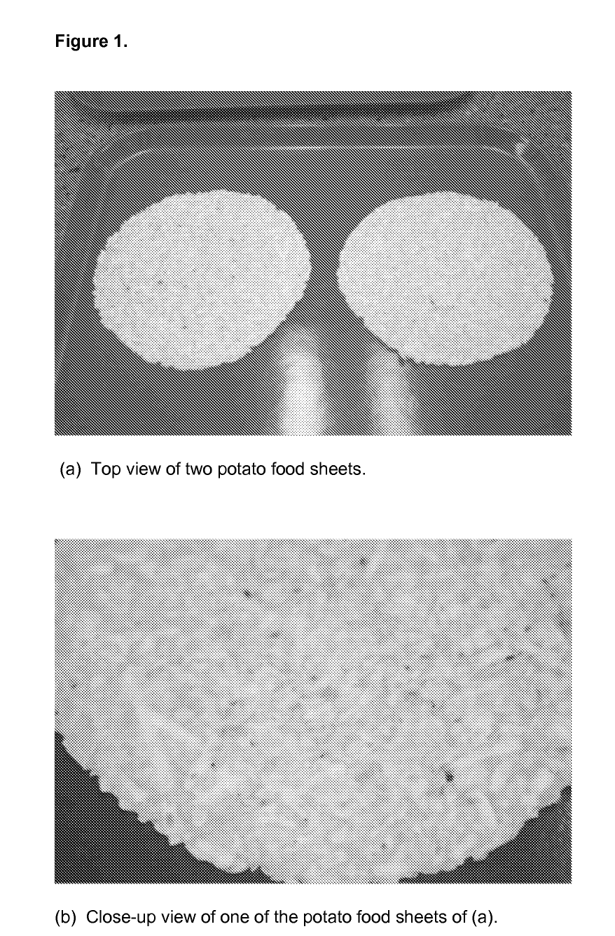

The present application relates to a food sheet comprising a flexible layer of vegetable pieces and a matrix formed from solidified gelling agents that hold the pieces together (FIG. 1). The food sheet is highly flexible and strong such that it is useful as a wrap for food fillings, as a flat base for toppings or for dipping into a sauce. The food sheet is designed to keep potato closer to its natural state than is found in conventional, heavily processed food sheets. The invention provides simplicity of design and an absence of complicated food ingredients.

The inventor has developed a food sheet made from vegetable pieces that has the strength and flexibility to be used as a sheet in place of wraps and other breads, noodles and chips. The sheet also stays intact after contact with water or oil from food fillings, such as liquid in sauces or fillings. The sheet will not degrade and allow food to contact a user's hand if the sheet is handheld. The sheet contains the food to prevent the food from dripping out of the wrapped food product.

The term “gelling agent” refers to a semi-solid or solid, resilient starch substance that adheres the vegetable pieces to one other. The gelling agent may or may not need to be activated, for example, by contact with water (heat may also be required for some gelling agents). Typically a “gelling composition” comprising a plurality of gelling agents adheres the vegetable pieces to one another. The gelling agent is typically a starch and the gelling composition is typically a starch composition.

The term “starch” refers to an edible polysaccharide (natural, processed or artificial) that adheres to root vegetable pieces, such as potato pieces. The term “starch composition” typically includes a combination of 2, 3 or more food starch products optionally in a carrier, such as water.

The term “matrix” generally refers to a flexible, solid substance in which vegetable pieces are wholly or partially embedded.

The term “shred” generally refers to narrow strips cut from vegetables. Typically, shred is in the form of uniform slices or splinters of freshly cut vegetable material that optionally have an oval, square or crescent shape. The individual shreds typically weigh approximately 1-2 grams and usually have random dimensions of approximately 1-4 mm thick×1-6 mm wide×up to 70 mm long typically with tapering at the end of the shred. The shreds optionally comprise peel or are free from peel. The vegetable shreds may be used either i) raw, ii) blanched and partially cooked or iii) fully cooked. Optionally the shreds are cooked then chilled, and used at room temperature (20-25° C.) or frozen.

The term “continuous” generally refers to an uninterrupted surface with no liquid-permeable gaps, holes, or folds that would allow liquid to leak through the surface.

The term “resiliently foldable” generally refers to a sheet can be folded at least 180 degrees, optionally at least 360 degrees, without rupture.

As used herein, the term “root vegetable” generally refers to plant tubers, such as stem tubers or root tubers used as vegetables. Root vegetables can include, but are not limited to: potatoes, sweet potatoes, yams, yucca, cassava, onions, shallots, carrots and taro. Therefore, the vegetable pieces are optionally potato or other root vegetables. The sheet can also be readily prepared free from allergens such as wheat (e.g. gluten) and egg.

In a particularly advantageous embodiment, the food wrap is principally made from potato simply cut in the form of a shred. Potato is a staple food that is well tolerated and accepted in a wide distribution of cultures and food styles as a source of nutrition. The present sheet is optionally formed from shredded potato and gelling agents and has the ability to be used as a food by itself or optionally folded and used as a food wrap. For example, in an embodiment of the invention, the food sheet consists of shredded potato and other non-glutinous gelling agents that yield a formable sheet of potato with clearly identified shreds of potato. The process of creating the sheet yields a flexible, foldable food wrapper that maintains the integrity of the shredded potato from which it was created.

The food sheet typically includes a flexible layer that includes vegetable pieces and gelling agents. The gelling agents form a matrix interacting with and adhering the vegetable pieces in the sheet. In one embodiment of the invention, the gelling agents are a plurality of starches.

The vegetable pieces of the food sheet are optionally shreds, dices or slices (ie. shredded vegetables, diced vegetables or sliced vegetables). Suitable dimensions of shreds, dices and slices will be readily apparent. The dimensions of suitable shreds are varied depending on the desired appearance and texture. For example for potato and other root vegetables, suitable shreds are optionally: 1 to 4, optionally 1 to 3 mm thick, 1 to 6 mm wide, optionally 1 to 3 mm wide, and 2 to 70 mm long, optionally 2 to 5 mm, or 2 to 10 mm or 2 to 20 mm or 2 to 50 mm long. The length of the shred can vary with the length of the root vegetable from which the shred is cut.

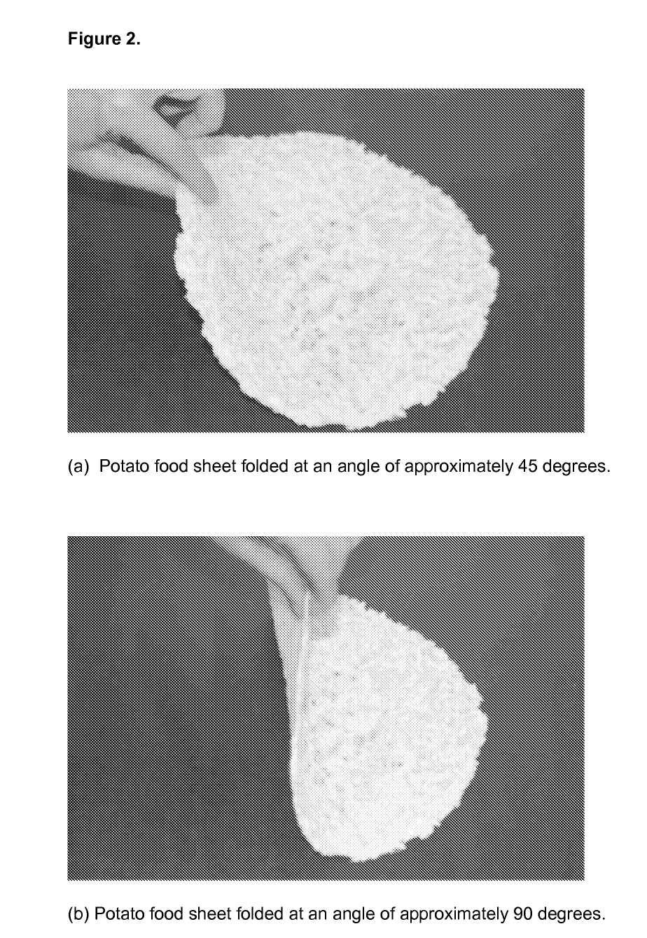

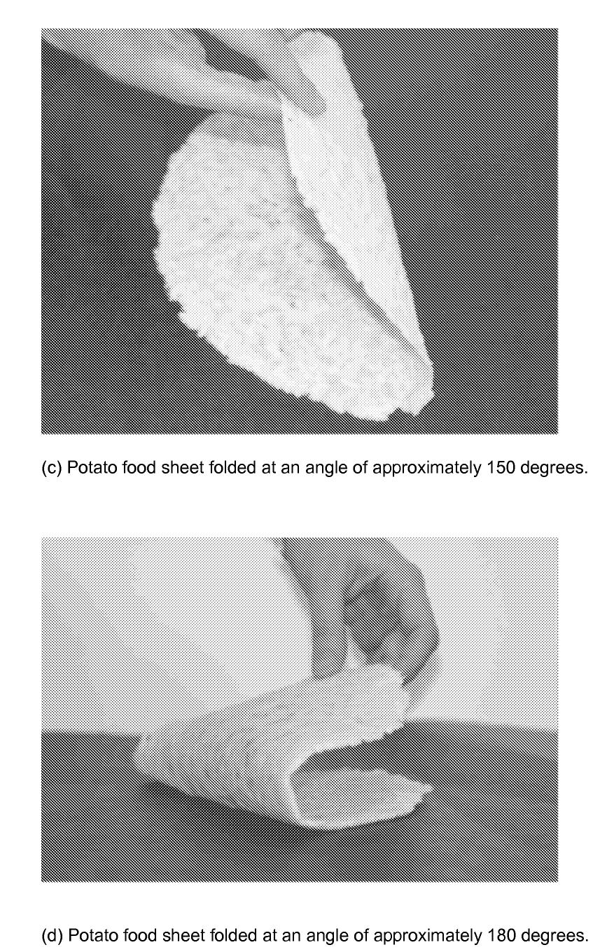

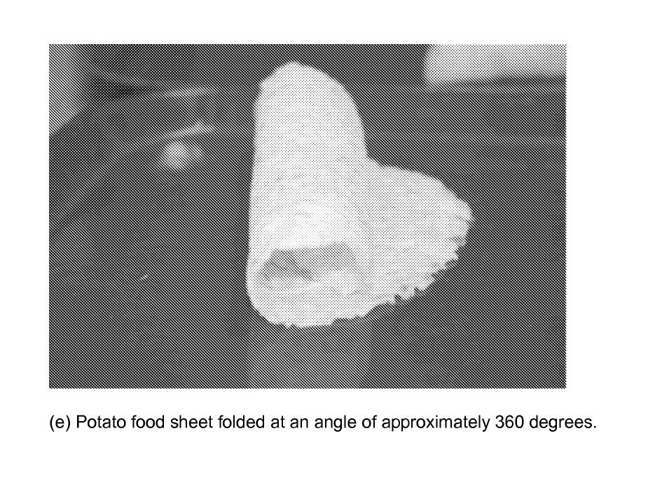

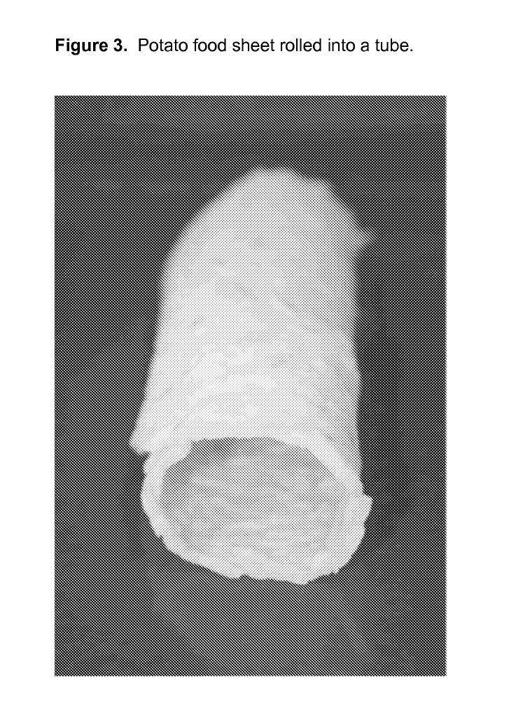

In a further embodiment of the invention, the flexible layer comprises interlaced vegetable shreds. The food sheet is typically formed in a continuous layer, which helps it avoid moisture leakage through the sheet when used to contain a secondary food filling. It is also typically resilient and bendable, optionally resiliently foldable and is readily bent without the continuous layer breaking or tearing. The food sheet can optionally be folded at least: 45, 90, 120, 150, 180, 200, 250, 300 or 360 or more degrees (see FIG. 1). In another embodiment of the invention, the food sheet is readily folded into a tube (FIG. 3), such as a cylinder shape, or folded into a pair of opposed semicircular surfaces. When two opposed ends of the food sheet meet, and are then viewed from the side, the two-dimensional shape of the sheet optionally appears rounded, such as circular, oval, O-shaped, obround or in an irregular shape having rounded portions. When the food sheet is folded but the ends of the sheet do not meet, the shape optionally appears arcuate, such as an arc, parabola, C-shape, U-shape (FIG. 2(d)), J-shape, S-shape or undulating shape. Dish or bowl shapes are also readily formed which is useful, for example, to allow the sheet to adapt to accommodate the shape of an underlying plate or bowl. It is also possible to fold the food sheet to form sharper edges, so that, if two opposed ends of the food sheet meet, the sheet optionally appears in a shape that is triangular or tetragonal, such as a rectangle, square or an irregular shape having three or four angles. When the food sheet is folded but the ends of the sheet do not meet, the shape optionally appears to have at least one angle, such as an L-shape, V-Shape or W-shape. Other shapes are also readily formed, such as conical shape or pie-shape. Irregular shapes having combinations of arcuate and/or angular portions are readily made by taking advantage of the flexibility of the sheets described herein. The pasta sheet is optionally entirely flat or it may be flat, with non-flat portions, such as crimped edges to help contain food or undulating edges, similar to a lasagna-style noodle.

The food sheet is typically 1 to 3 mm thick, 10 to 300 mm wide and 20 to 500 mm long. In another embodiment, the layer of the food sheet is 1 to 5 mm, optionally 2 to 4 mm or 3 to 4 mm, in thickness. Optionally, the sheet is no thicker than the thickness of the interlaced vegetable shreds. In yet another embodiment, the sheet is circular and typically 1 to 3 mm thick and 10 to 300 mm in diameter. The diameters that are common typically fall between 15 to 41 cm (6 to 16 inches). When the layer is circular, the ratio of the diameter to height of the sheet is optionally: 1-2:100, 1-2:250 or 1-2:500. According to one embodiment of the invention, the food sheet is a foldable wrap that is similar in thickness, shape and use to a tortilla.

In a further embodiment of the invention, the food sheet contains up to 5% of a secondary vegetable, typically also a root vegetable. In a further embodiment, the secondary ingredient is optionally sweet potato, carrot, garlic, ginger or onion. Secondary vegetables are useful to add flavour or texture to the sheet. They can also act as carriers for exogenous flavors. Secondary vegetables may either bind to the gelling agent (adherent secondary vegetables) or not bind to the gelling agent (non-adherent secondary vegetables). Adherent secondary vegetables are retained in the matrix by the gelling composition whereas non-adherent vegetables are retained in the matrix by the presence of the primary functional vegetable (e.g. potato) which does bind to the gelling composition. Adherent secondary vegetables bind well to the gelling agent, such that a sheet composed entirely of the adhering vegetable is resilient and foldable at least 45 degrees, 90 degrees, 150 degrees, 180 degrees or 360 or more degrees without tearing of the sheet.

In a further embodiment of the invention, the food sheet contains up to 5% by weight of a herb, seasoning or flavouring ingredient, such as oregano, basil, fennel, cumin, mustard, whole grains, cilantro or parsley.

In one embodiment of the invention, the gelling composition optionally includes a starch composition that comprises a plurality of starches. Typically, starches are combined to provide suitable adherence to root vegetable pieces to form the sheet. In another embodiment, starch types are blended to yield differing levels of flexibility in the food sheet.

Without wishing to be bound by theory, starch is a polysaccharide carbohydrate consisting of a large number of glucose units joined together by glycosidic bonds. Starch molecules normally arrange themselves in semicrystalline granules and become soluble in water when heated. In order to thicken (or “gelatinize”) starches, heat is necessary to break down the crystalline regions of the starch molecules in order to allow hydrogen bonding sites to engage water. Two different types of starches produced by starch manufacturers are “cook-up” starches and “instant” starches, which are categorized depending on the type of further processing required by a user to thicken a particular starch for use in food products. “Cook-up” starches require heat to be applied to solubilize and thicken the starches. For example, a finished food product manufacturer (e.g. a company that sells to restaurants, retail stores or directly to consumers) may buy a cook-up starch from a starch manufacturer and the food product manufacturer then adds water and heats the cook-up starch for use as a gelling agent in a starch composition at the plant to make root vegetable food sheets. In “instant” starches, the starch has typically been partially cooked and dried by a starch manufacturer such that the starch is soluble in water without heating (e.g. cold water or warm water with no heating requirement). For example, a starch manufacturer may partially cook the starch and dry it for sale to a food product manufacturer which then adds water to the instant starch for use as a gelling agent in a starch composition for root vegetable food sheets. It will be apparent that modified or unmodified starches are useful to make food sheets. Modified starches have been physically, chemically or enzymatically modified to allow the starch to function properly under conditions frequently encountered during processing or storage, such as high heat, low pH, freeze/thaw and cooling.

The starch composition of the invention optionally includes synthesized starches or derivatives/fractions of starch such as amylose, amylopectin or dextrins of various molecular weight. The sources of the starch are optionally genetically modified or non-genetically modified organisms that can be obtained through organic or conventional farming.

The starch composition in the food sheet optionally includes sago starch and waxy maize starch. In a further embodiment, the starches include: i) sago starch, ii) modified instant waxy maize starch and iii) modified cook-up waxy maize starch. Examples of useful commercially available starches are Advanta Gel®S, a modified sago starch manufactured by National Starch®, UltraSperse® M, a modified instant waxy maize starch manufactured by National Starch®, and Col Flo®67, a modified cook-up waxy maize starch manufactured by National Starch®.

Other useful starches are sago starch, waxy maize starch, maize starch, rice starch, waxy rice starch, barley flour/starch, pea flour/starch, potato starch, wheat starch, tapioca starch, lotus starch, sweet potato starch/flour or starch/flour from millets, pulses and lentils. Further suitable starches include unmodified sago starches such as Refined Sago Starch-NX 1806 from Nex-US Ingredients, modified waxy maize starches such as Polar-Tex® from Cargill Inc., CONSISTA®, Clearam®, Instant TenderGel®419, Instant TenderGel® 434, Instant TenderGel® 479 from Tate & Lisle, and Pregeflo® from Roquette, modified corn starches such as Hi-Form® from Cargill Inc., modified tapioca starches such as Binasol™ 90C and 95 from Tate & Lisle, and waxy potato starches such as Eliane™ from AVEBE.

Additional useful starches include starches that are viscoelastic in nature (optionally highly viscoelastic), resistant to shear, able to rapidly hydrate, resistant to retro-degradation and/or freeze-thaw stable. Useful cook-up starches include cook-up starches that are able to rapidly hydrate and have high viscoelastic properties. Optionally, the cook-up starches are able to hydrate or solubilize at a temperature of at least 40° C., optionally 55-95° C. or 80° C. Useful instant starches optionally include instant starches that are able to hydrate or solubilize at a temperature of 4-25° C.

The invention also relates to the food additive compositions per se (i.e. gelling compositions), not merely in combination with vegetable pieces. In one embodiment of the invention, the food additive composition contains a plurality of starches such as sago starch and waxy maize starch. In a further embodiment, the starches of the food additive composition include: i) sago starch, ii) modified instant waxy maize starch and iii) modified cook-up waxy maize starch.

The gelling or starch composition or food additive composition optionally contains one or more gums such as agar, alginate, arabic, carrageenan, carboxy methyl cellulose (CMC), gelatine, konjac flour, locust bean gum (LBG), methyl cellulose and hydroxypropyl methyl cellulose (MC/HPMC), microcrystalline cellulose (MCC), pectin and xanthan.

The invention also relates to a wrapped food product comprising a food wrap fully or partially wrapped around a filling. In a further embodiment of the invention, the food sheet of the wrapped food product is fully folded around the filling creating a food-tight seal by a user that prevents the filling from leaking through the sheet. The wrapped food product contains the filling when held upright. The filling of the food product or method optionally comprises egg, burrito filling, tortilla filling, samosa filling, egg roll filling, spring roll filling, sandwich meat, vegetables or cheese. The food wrap of the invention is useful as a breakfast meal where the wrap is formed around a food, such as scrambled eggs and bacon and then frozen for reconstitution in an appropriate oven or grill. The invention also relates to a method of preparing a wrapped food product comprising fully or partially folding the food wrap around a filling, wherein the food wrap contains the filling when held upright.

In yet another embodiment, the invention includes a noodle, such as a pasta style noodle, formed from the food sheet. In a further embodiment, the noodle is a lasagna noodle or a cannelloni noodle. In a further embodiment, the invention relates to a method of forming a food wrap or the food wrap in the form of a pasta noodle, comprising contacting root vegetable food pieces with the food additive composition and gelling the food additive composition to form a matrix around the food pieces.

A primary and compelling use for is to facilitate the functional inclusion of a potato product in the style of other bread wraps/tortillas for use in hand held wrapped food applications. The unique properties of the invention allow for use in “hand held” food wrap products such as a burrito or breakfast wrap where the filling would optionally contain eggs in one of several forms according to desired tastes. The filling of the potato wrap optionally includes, but is not limited to, egg, burrito filling, tortilla filling, samosa filling, egg roll filling, spring roll filling, sandwich meat, sliced cooked meats including beef, pork and chicken, vegetables or cheese.

### EXAMPLES

Embodiments of the food sheet and methods of preparation will be illustrated in a non-limiting way by reference to the examples below.

### Example 1

### Process for Making Potato Food Sheet

An example of a process is described, without limiting the scope of the process, since variations will be readily apparent. The process described below is also useful for other root vegetables, with adaptations as will be readily apparent to those of skill in the art.

1. Shreds of potato are prepared from sound, whole potatoes that have been washed, steam peeled, sorted for defects and sorted for suitability of further size reduction. The potatoes are optionally blanched to a temperature of 60° to 80° C., then cooled for a period of time to facilitate the development of a suitable texture for shredding and thereafter shredded by a mechanical shredder. Shreds are optionally uniform slices/splinters of freshly cut potato material that have a consistent shape, weigh approximately 1 to 2 grams and have random dimension consistent with an oval or crescent shape cut of potato shred, for example, dimension of approximately 3 mm thick×3 to 6 mm wide×10 to 70 mm long with a tapering at the end of the shred. The root vegetable shreds are optionally used fresh, chilled or frozen.

2. Shreds of potato are optionally mixed with three or more food starch products each of which imparts a unique textural effect to the mixture and to the outcome. The unique formulation of the shreds and food starch ingredients are mixed to a dough of uniform viscosity that is similar to loose bread dough or like a loose cookie dough with inclusions such as a macaroon dough.

3. The specific quantity of shred mixture desired to yield the finished food piece is weighed and portioned into a ball, then the ball of shred mixture is optionally pressure formed without heat to form a raw sheet. The pressure forming is optionally done by contacting the shred mixture with a pressure of 5 to 500 PSI. The pressure forming step is optionally conducted at ambient temperature, for example 16-25° C., 17-19° C. or 18° C. In another embodiment, the pressure forming step is optionally conducted at a temperature below ambient temperature, for example 4-18° C., preferably 4-8° C. Alternatively depending on the nature of the potato shred substrate, the raw material is contacted with a prescribed heat treatment and a pressure of 5 to 500 PSI. The shred mixture may be pressure formed between two pieces of parchment paper. In this embodiment, the raw sheet is released from the paper prior to cooking. The formed piece (raw sheet) is cooked gently to a temperature of approximately 80° C. This step surface cooks and set the starch so that it binds with the shredded potato to form the continuous seamless food sheet matrix, thereby forming the foldable food sheet, which typically turns light brown on portions of its surface. The cooking is optionally done after forming using a surface-heating device such as a belt cooker consisting of two independent non-stick (e.g. Teflon™) belts that convey the formed shred dough piece between two heated plates, to ensure the proper texture of the set under a slight compression. Alternately the cooking may be done using a continuous flat sheet cooking device such as a serpentine oven commonly used for the cooking of tortilla shells, or a stainless steel continuous belt cooker, typically with a 180° flip part-way (eg. halfway) through the cooking process. Alternately the cooking device may be a continuous fry pan in the style of a “Brat Pan.”

4. The resulting formed heated wrap may be frozen for storage, optionally between two pieces of non-stick parchment paper. The frozen shred wrap piece is typically brittle because of the unique texture of the shredded potato substrate, and protective packaging such as cardboard helps to maintain integrity. The frozen piece is readily reheated, for example, on a flat top grill common to any foodservice kitchen, or a fry pan, then used for the above-mentioned food wrapping uses. It is alternatively reheated in a microwave oven, typically until the surface of the sheet is warm or hot to touch. The resulting warmed food-ready shredded wrap becomes foldable and flexible for a variety of culinary uses and food wrapping applications.

### Example 2

### Formula—Food Sheet

The food wrap is optionally created by mixing frozen shredded potato that is allowed to thaw in a mixing device. To the shredded potato, optionally three or more non-glutinous starches are added, typically in succession, to bind and create the unique shred wrap dough. The starches are optionally pre-mixed in a composition and then added to the shred. The starches are readily prepared for use as known in the art, for example, the Col Flo® 67 cook-up starch is typically heated before addition to the shred. The proportions of this Example are optionally as follows:

| Ingredient | Quantity | Broad Useful Range | Typical Range |
|---|---|---|---|
| Shredded Potato | 900 g | 85-96% | 94-96% |
| UltraSperse ® M | 12 g | 0.05-2.00% | 1.0-1.5%; |
| | | | optionally 1.26% |
| Advanta Gel ® | 20 g | 0.05-2.5% | 1.7-2.5% |
| Col Flo ® 67 | 20 g | 0.05-2.5% | 1.7-2.5% |

A broad range is specified to show the flexibility of the process for making food sheets. Other ranges are also useful depending on the desired properties of the food sheet.

### Example 3

### Specifications of Shredded Potato

Shreds of potato are prepared from sound, whole potatoes that have been washed, steam peeled, sorted for defects, pre-heated to a temperature of 60° to 80° C. and then shredded and blanched at 60° to 85° C. for 10 to 15 minutes. Alternatively, shreds of potato are prepared from sound whole potatoes that have been washed, steam peeled, sorted for defects, pre heated to a temperature of 60° to 85° C., blanched for 10 to 20 minutes at 60 to 85° C., cooled at a temperature of 4° to 6° C. for 30 to 50 minutes to create a potato texture that will facilitate shredding, then shredded. Shreds are optionally uniform slices/splinters of freshly cut potato material that have a consistent shape, weigh approximately 1 to 2 grams and have random dimension consistent with an oval or crescent shape cut of potato shred, dimension of approximately 2 to 4 mm thick×3 to 6 mm wide×2 to 70 mm long—the length dependent on the length of the root vegetable shredded—with a tapering at the end of the shred. The root vegetable shreds are optionally used chilled or frozen and used later. Other shreds are also useful depending on the desired properties of the food sheet.

### Example 4

### Preparation of a Potato Food Sheet

Russet Burbank potatoes were peeled, blanched to a temperature of 74° C. for 30 minutes, and then cooled for 45 minutes at a temperature of 5° C. and then shredded. Potato shreds were then mixed with three starches and water in a manner that produced a dough and imparted minimal damage to the potato shreds. The three non-glutinous starches were added in succession to bind and create the unique shred wrap dough. Shreds are visibly apparent in the dough. The proportions of the shred wrap dough ingredients were as follows:

| Ingredient | Quantity | |
|---|---|---|
| Shredded Potato | 900 g | 94.54% |
| UltraSperse ® M | 12 g | 1.26% |
| Advanta Gel ® | 20 g | 2.10% |
| Col Flo ® 67 | 20 g | 2.10% |
| Total | 952 g | 100% |

This Example uses two modified waxy maize starches and a sago starch. Other starch combinations are useful. UltraSperse® M is a cold water swelling (instant) starch, while Col Flo® 67 was cooked. About 50 g of shred dough mixture was weighed and formed into a ball. The ball of shred mixture was pressure formed without heat using a tortilla press to achieve a disc shape, like a tortilla. Thickness of the raw sheet was about 2 mm. The formed piece was cooked on a Garland commercial griddle set at 185° C. The disc was cooked to a temperature believed to be approximately 80° C. to surface cook and set the starches that bind with the shredded potato to form the continuous seamless food sheet matrix. The food sheet was light brown on a portion of its surface. The individual food sheets were then frozen using a forced air blast freezer, and packaged between layers of silicone baking paper, and stored at −18° C. A food sheet prepared according to this Example is shown in FIG. 2(a) to (d). Other potatoes, vegetables and parameters are also useful depending on the desired properties of the food sheet.

It is to be understood that the invention is not limited in its application to the details set forth in the preceding description or exemplified by the Examples. The invention is capable of other embodiments or of being practiced or carried out in various ways. Also, it is to be understood that the phraseology and terminology employed herein is for the purpose of description and should not be regarded as limiting.

We claim:

1. A food sheet comprising a flexible layer of vegetable pieces and a gelling composition, the gelling composition forming a matrix adhering the pieces in the sheet.

2. The food sheet of claim 1, wherein the gelling composition comprises a starch composition.

3. The food sheet of claim 1, wherein the pieces comprise shreds, dices or slices with and without peel attached.

4. The food sheet of claim 1, wherein the layer comprises a continuous layer.

5. The food sheet of claim 1, wherein the flexible layer is resiliently foldable.

6. The food sheet of claim 1, folded at least 180 degrees or at least 360 degrees.

7. The food sheet of claim 3, wherein the pieces, shreds, dices or slices comprise root vegetable pieces, shreds, dices or slices, optionally with peel attached.

8. The food sheet of claim 7, wherein the root vegetable comprises potato shreds, optionally with peel attached.

9. The food sheet of claim 7, wherein the root vegetable comprises potato, sweet potato, yam, yucca, cassava, onion, shallot, carrot or taro.

10. The food sheet of claim 1, wherein the pieces are 1 to 3 mm thick, 1 to 6 mm wide and 2 to 50 mm long.

11. The food sheet of claim 1, wherein the layer is 1 to 5 mm in thickness.

12. The food sheet of claim 1, wherein the layer is circular and the ratio of the diameter to height of the sheet is optionally: 1-2:100, 1-2:250 or 1-2:500.

13. The food sheet of claim 1, wherein the layer comprises up to 10% of a second ingredient, optionally a root vegetable.

14. The food sheet of claim 13, wherein the second ingredient is onion or sweet potato.

15. The food sheet of claim 1, wherein the layer comprises up to 5% of a flavouring or seasoning.

16. The food sheet of claim 1, wherein the layer comprises up to 10% fruit pieces or fruit puree.

17. The food sheet of claim 2, wherein the starch composition comprises sago starch, waxy maize starch, maize starch, rice starch, waxy rice starch, barley flour/starch, pea flour/starch, potato starch, wheat starch, tapioca starch, lotus starch, sweet potato starch/flour or starch/flour from millets, pulses or lentils.

18. The food sheet of claim 17, wherein the starch composition comprises i) sago starch, ii) instant modified waxy maize starch and iii) cook-up modified waxy maize starch.

19. The food sheet of claim 18, wherein the food sheet is formed from 90-96% vegetable pieces by weight, 0.05-3% sago starch by dry weight, 0.05-3% instant modified waxy maize starch by dry weight and 0.05-3.5% cook-up modified waxy maize starch by dry weight.

20. A wrapped food product comprising the food sheet of claim 1, fully or partially folded around a filling to contain the filling.

21. A noodle comprising the food sheet of claim 1.

22. A method of preparing a wrapped food product comprising fully or partially folding the food sheet of claim 1 around a filling, wherein the food sheet contains the filling when held upright.

23. A food additive composition comprising sago starch and waxy maize starch.

24. The food additive composition of claim 23, wherein the food additive composition comprises i) sago starch, ii) instant modified waxy maize starch and iii) cook-up modified waxy maize starch.

25. The food additive composition of claim 24, wherein the food additive composition comprises sago starch, instant modified waxy maize starch and cook-up modified waxy maize starch in the ratio of 1:1:1 to 1.7:1:1.7 by dry weight.

26. A method of forming a food sheet, comprising:
contacting root vegetable food pieces with the food additive composition of claim 23;
forming the root vegetable food pieces into a raw sheet;
gelling the food additive composition to form a solid matrix around the root vegetable food pieces, thereby converting the raw sheet to the food sheet.
